(19) United States
(12) Patent Application Publication
(10) Pub. No.: US 2024/0292266 A1
(43) Pub. Date: Aug. 29, 2024

(54) WIRELESS COMMUNICATION SYSTEM, AGGREGATION DEVICE, INTERFERENCE SOURCE AIR TIME ACQUISITION METHOD, AND INTERFERENCE SOURCE AIR TIME ACQUISITION PROGRAM

(71) Applicant: Nippon Telegraph and Telephone Corporation, Tokyo (JP)

(72) Inventors: Junichi Iwatani, Tokyo (JP); Hiroyuki Nakamura, Tokyo (JP); Tomoaki Ogawa, Tokyo (JP); Makoto Umeuchi, Tokyo (JP); Shinya Otsuki, Tokyo (JP); Hiroshi Sakamoto, Tokyo (JP); Masayoshi Nabeshima, Tokyo (JP)

(21) Appl. No.: 18/627,643

(22) Filed: Apr. 5, 2024

Related U.S. Application Data
(63) Continuation of application No. 17/272,709, filed on Mar. 2, 2021, now Pat. No. 11,985,533.

(30) Foreign Application Priority Data
Sep. 20, 2018 (JP) 2018-176643

(51) Int. Cl. H04W 28/02; H04B 17/345; H04W 16/14; H04W 16/18; H04W 28/22

(52) U.S. Cl. CPC H04W 28/0236; H04B 17/345; H04W 16/14; H04W 16/18; H04W 28/22

(57) ABSTRACT

There are provided a plurality of radio devices detecting an interference source signal transmitted by an interference source and generating pieces of air time information showing whether the interference source signal exists or not for each predetermined time unit; and an aggregation device estimating air time of the interference source by acquiring the pieces of air time information from the plurality of radio devices and aggregating/integrating the acquired pieces of air time information for each predetermined unit time, matching timings.

### CROSS-REFERENCE TO RELATED APPLICATIONS

This application is continuation of U.S. application Ser. No. 17/272,709, filed Mar. 2, 2021, which claims the benefit of International Application No. PCT/JP2019/036095, filed Sep. 13, 2019, which claims priority to Japanese Application Serial No. 2018-176643, filed on Sep. 20, 2018. The disclosures of the prior applications are considered part of (and are incorporated by reference in) the disclosure of this application.

### TECHNICAL FIELD

The present invention relates to a radio communication system performing data communication using radio, the radio communication system acquiring a radio signal transmission state (air time) of an interference source (especially radio devices that are not management targets) near management target radio devices constituting the radio communication system, an aggregation device, an interference source air time acquisition method and an interference source air time acquisition program.

### BACKGROUND ART

Conventionally, it has been difficult to, when there is an interference source around management target radio devices, accurately grasp a degree of influence of the interference source. The reason is that radio base stations (APs) 10 and 20 in a radio communication system shown in FIG. 5 cannot detect an interference source signal transmitted by an interference source 51 if the radio base stations 10 and 20 are transmitting/receiving their signals, and a radio base station which is not transmitting/receiving signals can only fragmentarily grasp a radio signal transmission state (air time) of the interference source 51. Furthermore, it is also a reason that, since only information about a part of management target radio devices, especially the radio base stations 10 and 20 that are connected to an aggregation device (a server) 100 via a network is referred to, the amount of information is small.

For example, in a case described in Non-Patent Literature 1, the degree of influence of a nearby interference access point is only indicated by three stages, and detailed numerical values are not shown. Further, a channel use rate of only an interference source is not displayed.

### CITATION LIST

### Non-Patent Literature

Non-Patent Literature 1: “Wireless LAN Visualization Tool Function”, www.rtpro.yamaha.co.jp

### SUMMARY OF THE INVENTION

### Technical Problem

In order to solve the problem of the conventional technique, it is necessary to, though there are variations in the timing when management target radio devices can detect an interference source signal transmitted by an interference source, aggregate/integrate pieces of detection information of the management target radio devices. Furthermore, means for increasing reference information is required, such as not only performing monitoring only by radio base stations connected to a network but also referring to an interference source signal detected by radio terminals under control of the radio base stations.

An object of the present invention is to provide a radio communication system capable of detecting an interference source signal by management target radio devices, aggregating/integrating pieces of detection information of the management target radio devices and acquiring a radio signal transmission state (air time) of an interference source, an aggregation device, an interference source air time aggregation method and an interference source air time aggregation program.

### Means for Solving the Problem

A radio communication system of a first invention includes: a plurality of radio devices detecting an interference source signal transmitted by an interference source and generating pieces of air time information showing whether the interference source signal exists or not for each predetermined time unit; and an aggregation device estimating air time of the interference source by acquiring the pieces of air time information from the plurality of radio devices and aggregating/integrating the acquired pieces of air time information for each predetermined unit time, matching timings.

In the radio communication system of the first invention, the aggregation device may be configured to manage reference time T and a time unit D in order to match timings of the plurality of radio devices detecting the interference source signal, and notify the plurality of radio devices of the reference time T and the time unit D as air time management information. The plurality of radio devices are at least one radio base station connected to the aggregation device and at least one radio terminal under control of the radio base station, and the air time management information may be configured to be notified the radio base station from the aggregation device and further notified the radio terminal under the control of the radio base station from the radio base station.

In the radio communication system of the first invention, the plurality of radio devices may be configured to transmit detection levels of the interference source signal and pieces of position information about the radio devices to the aggregation device as the pieces of air time information; and the aggregation device may be configured to estimate a position of the interference source from the detection levels of the interference source signal at the plurality of radio devices and the pieces of position information about the plurality of radio devices.

In the radio communication system of the first invention, the aggregation device may be configured to analyze a tendency pattern of the estimated air time of the interference source, predict future air time of the interference source according to the tendency pattern, determine a transmission timing advantageous to the radio devices and notify the radio devices of the transmission timing.

A second invention is an aggregation device connected to a plurality of radio devices, the plurality of radio devices detecting an interference source signal transmitted by an interference source and generating pieces of air time information showing whether the interference source signal exists or not for each predetermined time unit, the aggregation device including processing means estimating air time of the interference source by acquiring the pieces of air time information from the plurality of radio devices and aggregating/integrating the acquired pieces of air time information for each predetermined unit time, matching timings.

An interference source air time acquisition method of a third invention includes the steps of: a plurality of radio devices detecting an interference source signal transmitted by an interference source and generating pieces of air time information showing whether the interference source signal exists or not for each predetermined time unit; and an aggregation device connected to the plurality of radio devices estimating air time of the interference source by acquiring the pieces of air time information from the plurality of radio devices and aggregating/integrating the acquired pieces of air time information for each predetermined unit time, matching timings.

An interference source air time acquisition program of a fourth invention causes a computer to execute a process executed by the aggregation device of the second invention to estimate air time of the interference source by acquiring the pieces of air time information from the plurality of radio devices and aggregating/integrating the acquired pieces of air time information for each predetermined unit time, matching timings.

### Effects of the Invention

The present invention can clarify a radio signal transmission state (air time) of an interference source by detecting an interference source signal by management target radio devices (a radio base station and radio terminals) and aggregating/integrating pieces of detection information, and, therefore, it becomes possible to grasp a degree of influence of the interference source.

Further, by referring to pieces of position information about the management target radio devices and detection levels of the interference source signal, it becomes possible to estimate a position of the interference source. Furthermore, by predicting future air time from past air time, appropriate transmission timing control for the management target radio devices becomes possible.

### BRIEF DESCRIPTION OF DRAWINGS

FIG. 1 is a diagram showing a first embodiment of interference source air time information aggregation in a radio communication system of the present invention.

FIG. 2 is flowcharts showing processing procedure examples of the interference source air time information aggregation in the first embodiment of the present invention.

FIG. 3 is a diagram showing an interference source position estimation example in a second embodiment of the present invention.

FIG. 4 is a diagram showing an example of use of air time of an interference source in a third embodiment of the present invention.

FIG. 5 is a diagram showing an example of detection of air time of an interference source in a conventional radio communication system.

### DESCRIPTION OF EMBODIMENTS

### First Embodiment

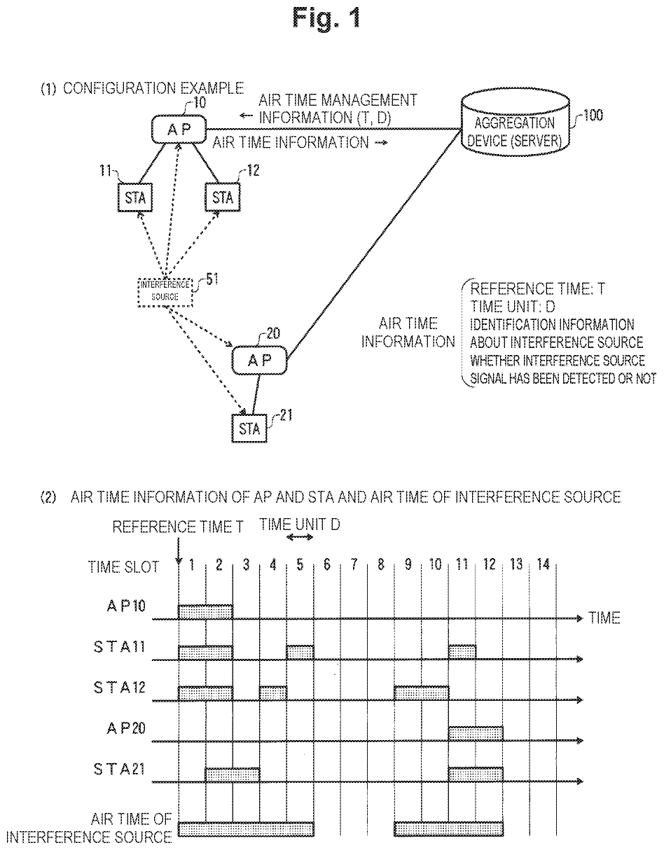

FIG. 1 shows a first embodiment of interference source air time information aggregation in a radio communication system of the present invention.

In FIG. 1, there are radio base stations (APs) 10 and 20 and radio terminals (STAs) 11, 12 and 21 under control of the radio base stations 10 and 20 as management target radio devices. Though only two radio base stations and three radio terminals are shown here for simplification, there may be more radio base stations and radio terminals. The radio base stations 10 and 20 communicate with an aggregation device (a server) 100 via a network not shown, and each of the radio terminals 11, 12 and 21 is connected to a radio base station to which the radio terminal belongs. It is assumed that an interference source signal transmitted by an interference source 51 is detected by each of the radio base station 10, the radio terminals 11 and 12, the radio base station 20 and the radio terminal 21.

Here, identification information about the interference source device is included in the interference source signal transmitted from the interference source 51, and the management target radio devices (the radio base station 10, the radio terminals 11 and 12, the radio base station 20 and the radio terminal 21) can identify the interference source 51 and grasp transmission time of the interference source signal transmitted by the interference source 51 by detecting the identification information.

The present invention is characterized in that, though the management target radio devices cannot detect the interference source signal transmitted by the interference source 51 while the management target radio devices are individually transmitting/receiving radio signals, it is possible for the aggregation device 100 to estimate air time of the interference source 51 by the aggregation device 100 aggregating/integrating pieces of detection information (pieces of air time information) about the interference source signal detected by the management target radio devices, while they are not performing transmission/reception, matching timings of the aggregation/integration.

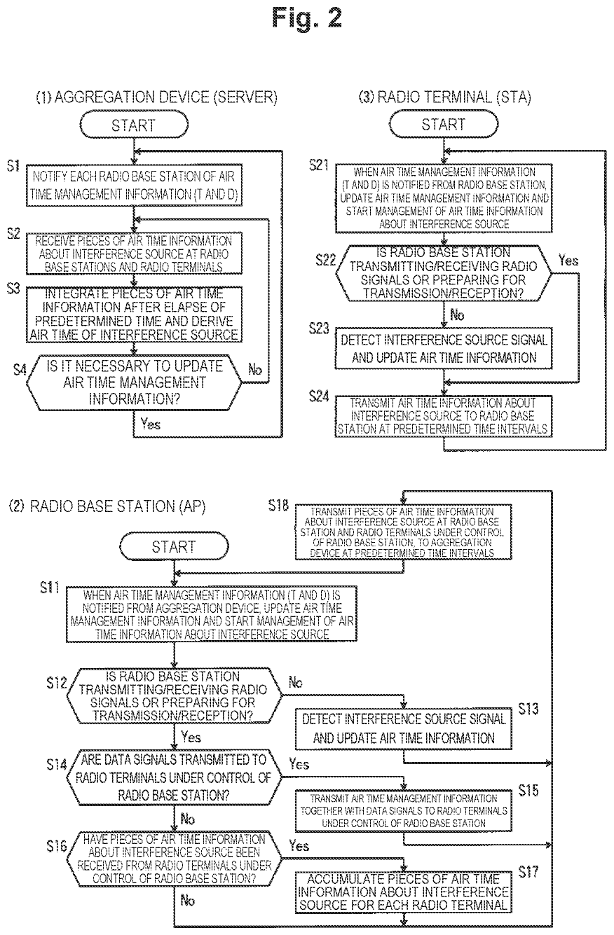

FIG. 2 shows processing procedure examples of the interference source air time information aggregation in the first embodiment of the present invention. FIG. 2 (1) shows a processing procedure example of an aggregation device (a server); FIG. 2 (2) shows a processing procedure example of a radio base station (AP); and FIG. 2 (3) shows a processing procedure example of a radio terminal (STA).

In FIG. 2, since the aggregation device aggregates/integrates pieces of air time information of an interference source signal detected by management target radio devices, it is necessary to match timings among the management target radio devices. The aggregation device manages the reference time T and the time unit D as air time management information and notifies each radio base station of the air time management information (S1). Note that, since the pieces of air time information are aggregated/integrated for each interference source, identification information identifying a target interference source is also necessary, but it is omitted here.

When the radio base station is notified of the air time management information (T and D) from the aggregation device, the radio base station updates previous air time management information and starts management of air time information about an interference source (S11). Here, if the radio base station is not transmitting/receiving radio signals or preparing for transmission/reception (S12: No), the radio base station detects an interference source signal and updates air time information (S13). Further, if the radio base station is transmitting/receiving radio signals or preparing for transmission/reception (S12: Yes), and data signals are to be transmitted to radio terminals under control of the radio base station (S14: Yes), the radio base station transmits the air time management information together with the data signals to the radio terminals under the control of the radio base station (S15). Further, if data signals are not to be transmitted to the radio terminals under the control of the radio base station (S14: No), and pieces of air time information about the interference source are received from the radio terminals under the control of the radio base station (S16: Yes), the radio base station accumulates the pieces of air time information about the interference source for each radio terminal (S17). The radio base station performs the above process at regular time intervals and transmits pieces of air time information about the interference source at the radio base station and the radio terminals under the control of the radio base stations, to the aggregation device (S18).

When the radio terminal is notified of the air time management information (T and D) from a radio base station to which the radio terminal belongs, the radio terminal updates previous air time management information and starts management of air time information about the interference source (S21). Here, if the radio terminal is not transmitting/receiving radio signals or preparing for transmission/reception (S22: No), the radio terminal detects the interference source signal and updates air time information (S23). The radio terminal transmits the updated air time information to the radio base stations at predetermined time intervals or each time of transmitting data to the radio base stations (S24).

The aggregation device receives pieces of air time information about the interference source at radio base stations and radio terminals under control of the radio base stations (S2), integrates the pieces of air time information for each time unit D after elapse of a predetermined time, derives air time of the interference source and updates a screen display and the like (S3). Here, the aggregation device returns to step S1 if it is necessary to update the air time management information (T and D), and returns to step S2 if it is not necessary to update the air time management information (T and D) (S4).

Note that the pieces of air time information about the interference source transmitted from the radio base stations and the radio terminals to the aggregation device includes the reference time T, the time unit D, identification information about the interference source, and whether an interference source signal is detected or not for each time unit D after the reference time T. Here, the reference time T and the time unit D that the aggregation device notifies the radio base stations and the radio terminals as the air time management information usually correspond to the reference time T and the time unit D transmitted from the radio base stations and the radio terminals to the aggregation device as the pieces of air time information. However, if update of the reference time T and the time unit D has not been performed in the radio base stations and the radio terminals due to non-delivery of the air time management information or the like, non-correspondence occurs. In this case, aggregation/integration is performed based on the pieces of air time information transmitted from the radio base stations and the radio terminals, and air time of the interference source is derived.

An example of aggregation/integration of pieces of air time information about an interference source in the first embodiment will be shown with reference to FIG. 1.

It is in time slots 1 and 2 as time units D with the reference time T as a starting point that the radio base station (AP) 10 detects an interference source signal. It is in time slots 1, 2, 5 and 11 that the radio terminal (STA) 11 detects the interference source signal. It is in time slots 1, 2, 4, 9 and 10 that the radio terminal (STA) 12 detects the interference source signal. It is in time slots 11 and 12 that the radio base station (AP) 20 detects the interference source signal. It is in time slots 2, 3, 11 and 12 that the radio terminal (STA) 21 detects the interference source signal.

For example, in the time slot 1, the AP 10 and the STAs 11 and 12 detect the interference source signal because they are not performing transmission/reception, and the AP 20 and the STAs 21 cannot detect the interference source signal because they are performing transmission/reception. In the time slot 4, the AP 10, the STA 11, the AP 20 and the STA 21 are performing transmission/reception and cannot detect the interference source signal, and only the STA 12 can detect the interference source signal because it is not performing transmission/reception. In time lots 6 to 8, the interference source signal cannot be detected because the interference source signal is not transmitted or because all of the AP 10, STAs 11 and 12, the AP 20, the STA 21 are performing transmission/reception.

Thus, detection of an interference source signal by APs and STAs can be performed when the interference source signal is transmitted from an interference source, and, furthermore, the APs and the STAs are not performing transmission/reception. On this assumption, the aggregation device 100 grasps air time of an interference source by aggregating/integrating (taking a logical sum of) pieces of air time information of radio devices for each time slot (each time unit D).

### Second Embodiment

As the air time information, a management target radio device may add position information about the management target radio device and a detection level of an interference source signal, in addition to the reference time T, the time unit D, identification information about an interference source, and whether the interference source signal is detected or not for each time unit D after the reference time T. For example, at step S13 in FIG. 2 (2), when detecting an interference source signal, the radio base station updates air time information including a detection level of the interference source signal. Further, at step S23 in FIG. 2 (3), when detecting an interference source signal, the radio terminal updates air time information including a detection level of the interference source signal. Then, at step S18 in FIG. 2 (2), when transmitting pieces of air time information about an interference source at the radio base station and radio terminals to the aggregation device, the radio base station includes pieces of position information about the radio base station and the radio terminals.

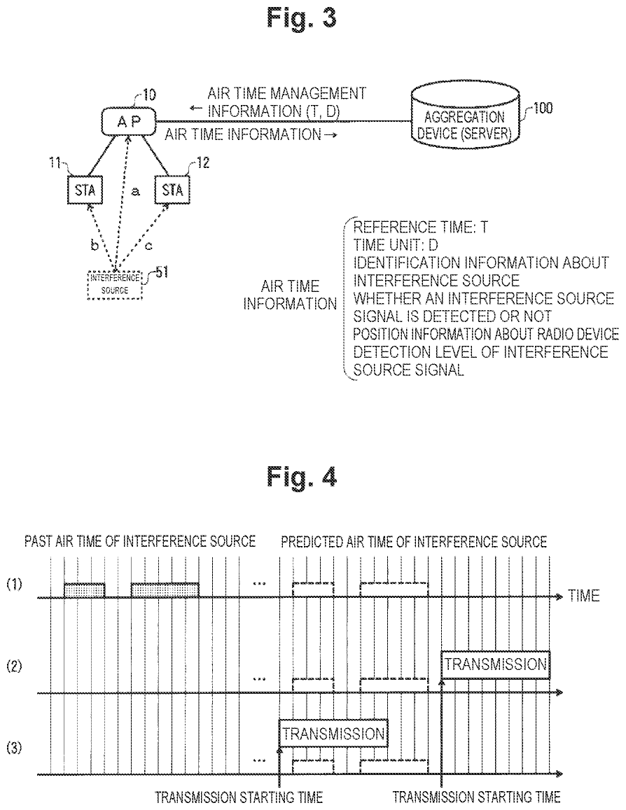

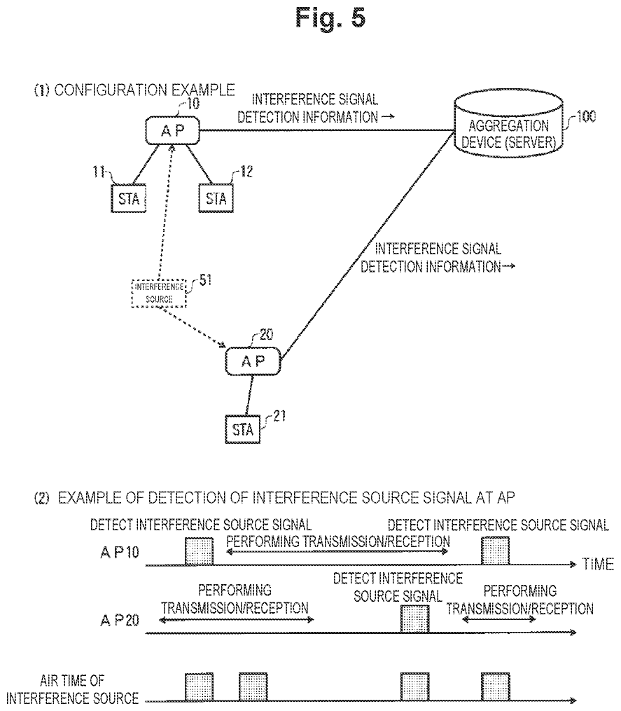

Thereby, the aggregation device can calculate a ratio (a:b:c) of distances to the interference source 51, from detection levels of the interference source signal at the radio base station 10 and the radio terminals 11 and 12 under control of the radio base station 10 as shown in FIG. 3. The aggregation device 100 can estimate a position of the interference source 51 by three-point positioning, from pieces of position information about the radio base station 10 and the radio terminals 11 and 12, and the ratio (a:b:c) of the distances to the interference source 51.

Further, by adding detection levels of the interference source signal at the radio base station 20 and the radio terminal 21 under control of the radio base station 20 and pieces of position information about the radio base station 20 and the radio terminal 21 shown in FIG. 1, the aggregation device 100 can estimate the position of the interference source 51 more accurately.

### Third Embodiment

The aggregation device 100 can take countermeasures by displaying air time information about the interference source 51 on a screen to visualize the air time information. For example, if the aggregation device 100 analyzes a tendency of the air time of the interference source 51 and knows patterns, such as concentrated use in a particular time zone and an unused state after use for a predetermined time, specific measures become possible.

Furthermore, the aggregation device 100 predicts future air time from past air time of the interference source 51 as shown in FIG. 4 (1), and, in order to avoid a predicted transmission timing of the interference source 51, notifies management target radio devices of transmission starting time avoiding the transmission timing of the interference source 51, as a transmission timing advantageous to the management target radio devices, as shown in FIG. 4 (2). Or alternatively, by the aggregation device 100 notifying transmission starting time prior to the transmission timing of the interference source 51 as shown in FIG. 4 (3), it becomes possible for the management target radio devices to perform transmission without being influenced by the interference source 51. At this time, the interference source 51 is disabled to transmit a signal by carrier sense.

The aggregation device 100 described above can be realized by a computer and a computer program. The computer program can be stored in a computer-readable storage medium or can be provided via a network.

### REFERENCE SIGNS LIST

10, 20 Radio base station (AP)
11, 12, 21 Radio terminal (STA)
51 Interference source
100 Aggregation device (server)

1. (canceled)

2. (canceled)

3. (canceled)

4. A radio communication system comprising:
a plurality of radio devices each detecting an interference source signal transmitted by an interference source and each generating pieces of air time information each indicating a transmission status of the signal from the interference source at each predetermined time unit; an aggregation device for estimating the air time of the interference source by acquiring the pieces of air time information from the plurality of radio devices respectively and aggregating/integrating the acquired air time information for each predetermined time unit.

5. The radio communication system according to claim 1, wherein the aggregation device is configured to manages reference time T and the time unit D in order to match the timing of the plurality of radio devices detecting the interference source signal.

6. The radio communication system according to claim 1, wherein
the plurality of radio devices are configured to transmit detection levels of the interference source signal and pieces of position information about the radio devices to the aggregation device as the pieces of air time information; and
the aggregation device is configured to estimate a position of the interference source from the detection levels of the interference source signal at the plurality of radio devices and the pieces of position information about the plurality of radio devices.

7. The radio communication system according to claim 1, wherein
the aggregation device is configured to analyze a tendency pattern of the estimated air time of the interference source, predict future air time of the interference source according to the tendency pattern, determine a transmission timing advantageous to the radio devices and notify the radio devices of the transmission timing.

8. An aggregation device connected to a plurality of radio devices, the plurality of radio devices each detecting an interference source signal transmitted by an interference source and each generating pieces of air time information indicating a transmission status of the signal from the interference source at each predetermined time unit, the aggregation device comprising:
circuitry for estimating the air time of the interference source by acquiring the pieces of air time information from the plurality of radio devices respectively and aggregating/integrating the acquired pieces of air time information for each predetermined time unit.

9. A radio communication method comprising:
causing a plurality of radio devices respectively to detect an interference source signal transmitted by an interference source;
causing the plurality of radio devices respectively to generate pieces of air time information indicating the presence or absence of the interference source signal for each predetermined time unit;
acquiring the pieces of air time information from the plurality of radio devices, respectively; and
estimating the air time of the interference source by aggregating/integrating the acquired air time information for each predetermined time unit.
